(19) United States
(12) Patent Application Publication
(10) Pub. No.: US 2010/0028475 A1
(43) Pub. Date: Feb. 4, 2010

(54) COMPRESSION MOLDING METHOD AND DEVICE THEREFOR

(76) Inventors: Shinya Takeuchi, Kyoto-shi (JP); Toshitsugu Fujimura, Kyoto-shi (JP)

Correspondence Address: WENDEROTH, LIND & PONACK, L.L.P., 1030 15th Street, N.W.,, Suite 400 East, Washington, DC, 20005-1503, US

(21) Appl. No.: 12/556,908

(22) Filed: Sep. 10, 2009

Related U.S. Application Data
(62) Division of application No. 11/922,922, filed on Dec. 27, 2007.

(30) Foreign Application Priority Data
Jun. 30, 2005 (JP) 2005-192634

(51) Int. Cl. B28B 7/36

(52) U.S. Cl. 425/89

(57) ABSTRACT

A compression molding method capable of preventing contamination of abrasion powders generated by scoring to thereby improve the product yield is provided. The compression molding method, including a fixed mold and a movable mold arranged opposite each other, includes: contacting a slide board connected with a movable die plate on the movable mold side via a spring, with the parting face of the fixed mold by a spring force; further advancing the movable mold after injecting resin into a cavity in the mold, and compressing and molding the resin filled in the cavity by a core, provided in the movable mold, penetrating through the slide board. A resin film is disposed between the fixed mold and the slide board, and one surface of the resin in the cavity is compressed by the core via the resin film.

### TECHNICAL FIELD

The present invention relates to a compression molding method using a core compression mold and a device therefor.

### BACKGROUND ART

Conventionally, a core compression mold is used for molding spectacle lenses, optical lenses and the like.

Such a kind of mold consists of a fixed mold 50, a movable mold 51 and a runner plate 52 interposed between them, as shown in FIG. 8.

In the fixed mold 50, a runner 50a and a mold cavity 53 communicating with the runner 50a are formed.

In the movable mold 51, a core 54 is provided penetrating through the runner plate 52 at a position opposite to the mold cavity 53. The core 54 is adapted to move back and forth relative to the mold cavity 53 corresponding to the movement of a core cylinder 55.

In the case of carrying out molding by using the core compression mold, clamping is performed in a state that the core 54 is retreated to thereby cause a large clamping force to act on a parting face 56 where the fixed mold 50 and the runner plate 52 contact each other.

Next, molten resin from an injector is injected into the mold cavity 53 through the runner 50a.

Then, the core 54 is advanced by operating the core cylinder 55 so as to compress the molten resin inside the mold cavity 53 to thereby produce a molded product E (see, for example, Japanese Patent Laid-Open Publication No. 11-179769).

### DISCLOSURE OF THE INVENTION

In the core compression mold, however, sliding surfaces between the core 54 and the runner plate 52 may be worn to thereby cause so-called “scoring”.

Scoring is classified according to the causes into a) abrasive wear which is easily caused if materials of the sliding mold components include differences in hardness, b) adhesive wear in which protrusions of mold components collide against each other whereby adhesion is easily caused in the part of the hardest contact, and the adhesion is dropped to thereby form abrasion powders, and c) fatigue wear in which mold components are tired and worn, for example.

Scoring is caused due to various causes as described above, and if abrasion powders are contaminated in molded products, they should be disposed as waste, causing a drop in the product yield and also damaging the mold. Further, if a clearance of the core sliding part is large, there is a problem that resin is immersed into the core sliding part to thereby cause burrs.

The present invention has been developed considering the problems in the conventional compression molding method using a core compression mold as described above. It is therefore an object of the present invention to provide a compression molding method and a device therefor, capable of preventing contamination of abrasion powders caused by scoring to thereby improve the product yield, and further increasing the service life of the core compression mold.

A compression molding method of the present invention to achieve the above mentioned object is a method including a fixed mold and a movable mold arranged opposite each other, comprising the steps of: contacting a slide board connected with a movable die plate on the movable mold side via a spring with a parting face of the fixed mold by the spring force; further advancing the movable mold after supplying resin into a cavity inside the mold, and compressing and molding the resin filled in the cavity by a core, provided in the movable mold, penetrating through the slide board. The method is characterized in that a thermoplastic resin film is disposed between the fixed mold and the movable mold, and one surface of the resin in the cavity is compressed by the core via the thermoplastic resin film.

According to the compression molding method of the present invention, when the resin film is interposed between the fixed mold and the movable mold and the resin is supplied into the cavity in a state where the core is recessed, the supplied resin presses the resin film to adhere to the core. Then, when the core advances while the spring shrinks by further advancing the movable mold, the molded resin is compressed by the core which is covered with the thermoplastic resin film. That is, resin molding is performed without being influenced by abrasion powders generated in the sliding part since the thermoplastic resin film is provided between the sliding core and the molded resin as a divider.

In the compression molding method, it is preferable to use a polyester film having a thickness of 20 to 200 μm as the thermoplastic resin film.

In the compression molding method, a base film of a transfer film on which a design is formed may be used as the thermoplastic resin film.

In such a case, the design can be transferred onto the decorating face by arranging the transfer film such that the design faces the fixed mold side, and after positioning the resin to be supplied into the cavity and the design of the transfer film, supplying the resin into the cavity in the mold and compressing the decorating face of the resin filled in the cavity by the core via the transfer film. Thereby, it is possible to realize preventing abrasion powders generated in the core sliding part from being mixed, as well as transferring the design.

In the compression molding method, it is preferable to supply the resin into the cavity after causing the thermoplastic resin film disposed between the fixed mold and the movable mold to be adsorbed to the compression face of the core.

Further, a compression molding device of the present invention is a device having a fixed mold and a movable mold arranged opposite each other, in which a slide board connected with a movable die plate on the movable mold side via a spring is contacted with a parting face of the fixed mold by a spring force, and the movable mold is further advanced after resin is supplied into a cavity inside the mold, and the resin filled in the cavity is compressed and molded by a core, provided in the movable mold in state of penetrating through the slide board. The device is characterized as to be configured such that one surface of the resin in the cavity and the core is divided with a thermoplastic resin film at a time of compression molding.

In the compression molding device, the thermoplastic resin film may be formed of a resin film in a band shape, and may be configured so as to be unwound from a roll and to pass through the mold intermittently.

According to the compression molding method and the compression molding device of the present invention, it is possible to prevent contamination of abrasion powders generated by scoring to thereby improve the product yield, and also to increase the service life of the mold.

### BRIEF DESCRIPTION OF THE DRAWINGS

FIG. 1 is a configuration diagram of a mold used in a compression molding method according to the present invention;

FIGS. 2a to 2e are process diagrams for explaining the compression molding method according to the present invention;

FIG. 3 is a cross-sectional view of a transfer film used in the present invention;

FIGS. 4a to 4e are process diagrams for explaining a compression molding method using a transfer film;

FIGS. 5a and 5b are pictures of molded product molded by means of a conventional compression molding method, in which FIG. 5a is a micrograph taken with a magnification rate of 50 times, and FIG. 5b is a micrograph taken with a magnification rate of 500 times;

FIG. 6 is a micrograph in which FIG. 5b is further magnified 3500 times;

FIGS. 7a and 7a are pictures of a molded product molded by means of the compression molding method according to the present invention, in which FIG. 7a is a micrograph taken with a magnification rate of 50 times, and FIG. 7a is a micrograph taken with a magnification rate of 500 times; and

FIG. 8 is a sectional view showing the configuration of a conventional compression mold.

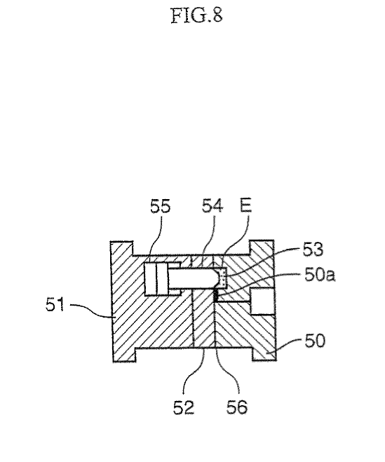

### DESCRIPTION OF THE PREFERRED EMBODIMENT

Hereinafter, the present invention will be explained in detail based on an embodiment shown in the drawings.

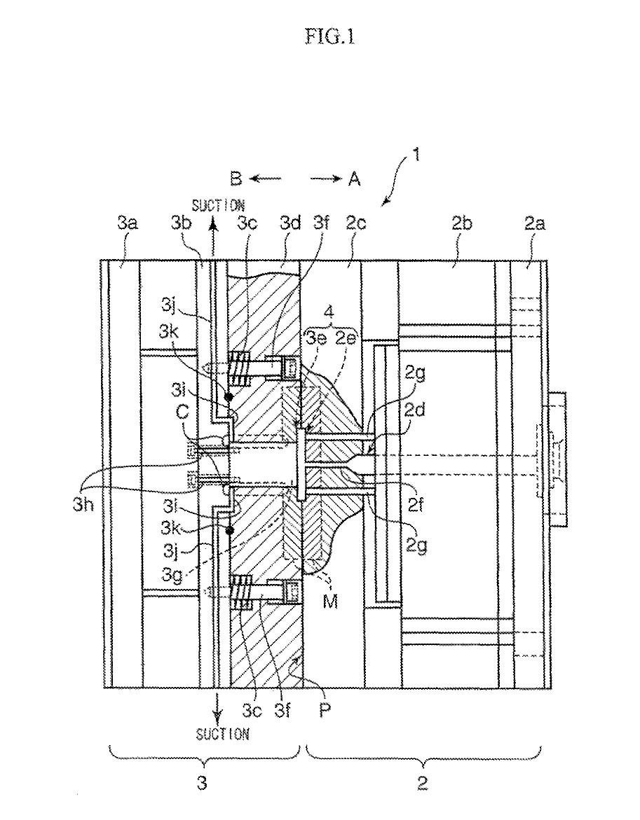

FIG. 1 shows the configuration of a core compression mold (hereinafter abbreviated as a mold) used in a compression molding method according to the present invention.

In FIG. 1, a mold 1 includes a fixed mold 2 and a movable mold 3. A mold mounting board 2a of the fixed mold 2 is provided with a fixed die plate 2c via a spacer block 2b, and the fixed die plate 2c is provided with a hot runner 2d.

In a dented part defined by the fixed die plate 2c and a slide board 3d described later, a nest block M divided into left and right parts by a parting face P is fitted. On the fixed mold side of the nest block M, one side of a cavity 4 into which molten resin is filled is formed as a first cavity 2e, to which a nozzle 2f of the hot runner 2d is communicated. Note that the reference numeral 2g denotes an ejector pin. Further, an inclined pin (not shown) for forming an undercut part in a pawl shape may be provided if required. This is due to the fact that an inclined pin and a core 3g described later will not interfere with each other in the present configuration.

The movable mold 3 is arranged opposite the fixed mold 2, and a mold mounting base 3a of the movable mold 3 is provided with a movable die plate 3b.

The movable die plate 3b is provided with the slide board 3d via springs 3c. In the slide board 3d, a second cavity 3e is formed opposite the first cavity 2e. The reference numeral 3f indicates a compression allowance adjusting bolt which is arranged coaxially with the spring 3c.

Further, the slide board 3d is provided with the core 3g penetrating through the slide board 3d in a left and right direction.

The back end of the core 3g is fixed to the movable die plate 3b via core fixing bolts 3h. When the slide board 3d is moved in a direction of the arrow A against the urging force of the springs 3c and 3d to closely adhere to the fixed die plate 2c, the slide board 3d is retreated in a direction of the arrow B whereby the core 3g advances relatively, whereby the molten resin filled in the cavity 4 is compressed.

Note that the compression range by the core 3g may be a part or the whole of the cavity 4.

A thermoplastic resin film (hereinafter abbreviated as a film), described later, is disposed between the fixed die plate 2c and the slide board 3d of the mold 1. The film is formed of one in a band shape unwound from a roll. Each time compression molding is carried out, it moves intermittently with a predetermined length so as to be fed into the mold 1. The film provided for molding is to be sent outside the mold after released from the mold and wound up by a wind-up roll (not shown).

Further, in the movable mold 3, suction passages 3i and 3j are formed, communicating with a gap in the core sliding part C. The suction passage 3j penetrates through the movable die plate 3b and connects with a vacuum pump (not shown) outside the movable mold 3. Thereby, when suction is carried out through the suction passages 3i and 3j, the film disposed between the fixed mold 2 and the movable mold 3 can adhere closely to the compression face of the core 3g, so as to prevent wrinkles from being caused on the resin surface to be molded. Note that the reference numeral 3k, in the Figure, denotes a seal member consisting of an O ring, for example, which enables suction even if the movable die plate 3b and the slide board 3d are separated.

As a material of the film, a heat-resistant polyester film, especially PET (polyethylene terephthalate) is preferable to be used specifically, but it is not limited to this material. A single-layer film selected from polycarbonate resin, polyamide resin, polyimide resin, polyester resin, acrylate resin, olefin resin, urethane resin, acrylonitrile-butadien-styrene resin, vinyl chloride resin and the like, or a laminated film or a copolymer film made of not less than two kinds of resins selected from those mentioned above can be used.

When the molten resin inside the cavity 4 is compressed by the core 3g, breaking force is acted on the film. Therefore, the thickness of the film must be selected to be able to counter the breaking force.

As a film thickness capable of countering the breaking force, one having 20 μm or more may be used, but since a resin thickness to be formed is affected if the thickness exceeds 200 μm, it is preferable to select the thickness in a range from 20 to 200 μm.

Furthermore, it is preferable to select the thickness in a range from 20 to 100 μm for high-accuracy molding.

As molten resin to be filled in the mold 1, general-purpose resin such as polystyrene-type resin, polyolefin-type resin, ABS resin, AS resin, AN resin or the like is shown. In addition, general-purpose engineering resin such as polyphenylene oxide polystylene resin, polycarbonate-type resin, polyacetal-type resin, acrylic resin, polycarbonate modified polyphenylene ether resin, and poly butylene terephthalate resin, and super engineering resin such as polysulfone resin, polyphenylene-sulfide-type resin, polyphenylene-oxide-type resin, polyallylate resin, polyether imide resin, polyimide resin, liquid crystal polyester resin, and polyallyl type heat-resistant resin may be used. Note that a composite resin to which a reinforcing material such as glass fiber or inorganic filler is added is also included as the molted resin.

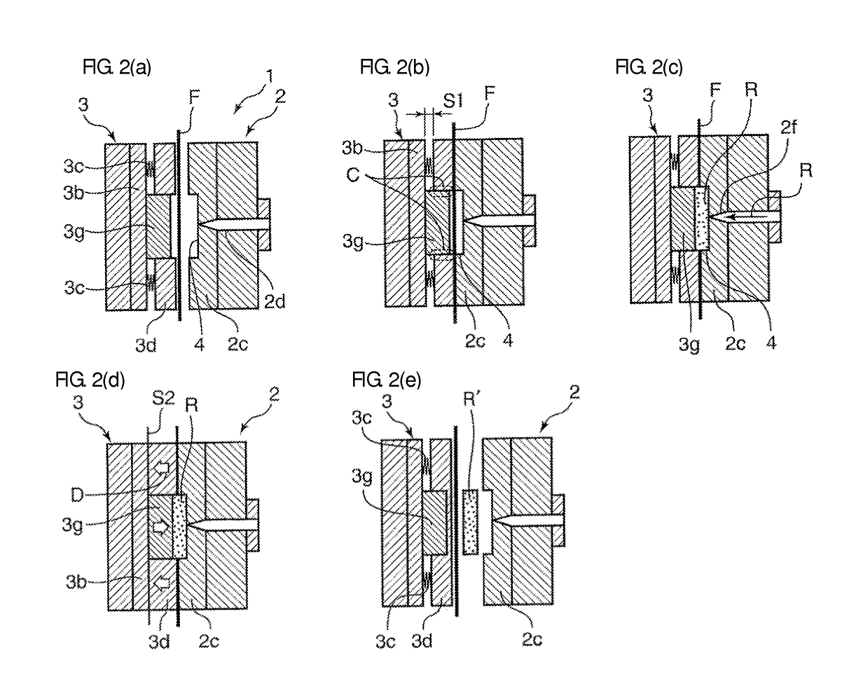

Next, a compression molding method using a film will be described with reference to the principle diagrams of FIGS. 2a to 2e.

In FIGS. 2a to 2e, step (a) shows a film disposing state, step (b) shows a mold touching state, step (c) shows a mold resin injecting/filling state, step (d) shows a compressing state, and step (e) shows a mold removing state, respectively.

In step (a), a film F is inserted in between the fixed mold 2 and the slide board 3d of the movable mold 3.

Next, as shown in step (b), the movable mold 3 is moved to the fixed mold 2 side, and the slide board 3d is contacted with the fixed die plate 2c by the spring force. The compression allowance of the springs 3c and 3c is set to 0.3 mm, for example.

Then, as shown in step (c), molten resin R is filled in the cavity 4 from the nozzle 2f. At this time, the film F is closely contacted to the compression face of the core 3g.

Then, as shown in step (d), the movable mold 3 is moved such that the compression allowance S2 of the springs becomes 0 mm, thereby the slide board 3d is closely contacted with the movable die plate 3b.

At this time, corresponding to the slide board 3d being retreated in a direction of the arrow D, the core 3g advances to a direction opposite to the direction of the arrow D relatively, and the end face of the front side (compressed face) presses the molten resin R via the film F.

Then, when the molten resin R is hardened, the movable mold 3 is separated from the fixed mold 2 so as to separate a molded product R′ from the mold, as shown in step (e).

In the compression molding, the film F is interposed between the core 3g and the resin molded surface, so even if abrasion powders are generated in the core sliding part C where the core 3g and the slide board 3d slidingly move to each other, it is possible to prevent the abrasion powders from being contaminated in the molded resin R.

As described above, by performing compression molding in a state where the film F is interposed between the fixed mold 2 and the movable mold 3, it is possible to surely solve a reduction in yield affected by abrasion powders generated in the core sliding part C.

Further, in the compression molding, when the film F is softened with heat, it also becomes to have adherence at the same time. Therefore, abrasion powders easily adhere to the heated film F, and when the film F is sent outside the compression mold after separated from the mold, the abrasion powders will be discharged from the mold 1 together with the film F. Consequently, each time compression molding is carried out, abrasion powders generated in the core sliding part C are discharged outside the compression mold 1, whereby the mold service life can be longer.

Moreover, since it is possible to prevent resin from being intruded into the core sliding part C, occurrence of burrs can be solved.

The film F used in the above-described embodiment may be substituted with a transfer film. In such a case, it is possible to solve a reduction in the yield caused by abrasion powders and also to decorate the molded product at the same time.

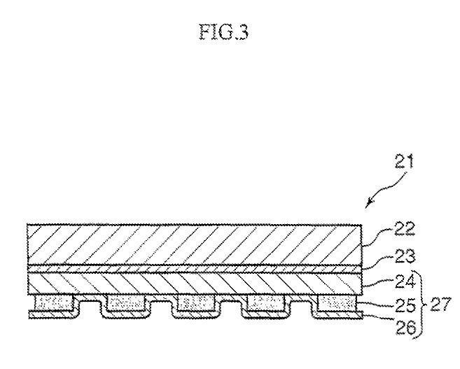

FIG. 3 shows the configuration of a transfer film.

A transfer film 21 consists of a base film 22, a separation layer 23, a peel-off layer 24, a design layer 25, and an adhesive layer 26. Note that in the explanation below, the peel-off layer 24, the design layer 25 and the adhesive layer 26 may be collectively called as a decorative layer 27.

As a material of the base film 22, PET (polyethylene terephthalate) excellent in heat resistance is shown, but it is not limited to this material. A single-layer film selected from polycarbonate resin, polyamide resin, polyimide resin, polyester resin, acrylic resin, olefin resin, urethane resin, acrylonitrile-butadien-styrene resin, vinyl chloride resin and the like, or a laminated film or a copolymer film made of not less than two kinds of resin selected from those mentioned above can be used.

As for the thickness of the base film 22, it is confirmed that one having a thickness of 38 μm will not brake up to the compression amount of 0.3 mm, and one having a thickness of 50 μm will not brake up to the compression amount of 0.5 mm. Therefore, when carrying out inmold printing by using the mold 1, the thickness of the base film 22 can be decided within a rage from 38 to 50 μm corresponding to the compression amount, but when considering the handling ability, it is preferable to use one having 38 μm.

The peel-off layer 24 forms the outermost face after the design is transferred and the base film 22 is peeled, and serves as a protective film for the design.

The materials of the peel-off layer 24 include acrylic-type resin, nitrocellulose-type resin, polyurethane-type resin, chlorinated rubber-type resin, vinyl chloride-vinyl acetate copolymer type resin, polyamide-type resin, polyester-type resin, epoxy-type resin, polycarbonate-type resin, olefin-type resin, and acrylonitrile-butadien-styrene resin. The film thickness of the peel-off layer 24 is preferably in a range of 0.5 to 50 μm.

The separation layer 23 is a layer in which surface processing is carried out to the base film 22. This is for smoothing peeling between the base film 22 and the peel-off layer 24. Therefore, the separation layer 23 may be omitted if peeling can be performed only with the base film 22 and the peel-off layer 24. The material of the separation layer 23 may be made of one same as that of the peel-off layer 24.

The design layer 25 including characters, symbols, patterns and coating patterns is enclosed between the peel-off layer 24 and the adhesive layer 26. The materials of the design layer 25 include acrylic-type resin, nitrocellulose-type resin, polyurethane-type resin, chlorinated rubber type resin, vinyl chloride-vinyl acetate copolymer type resin, polyamide-type resin, polyester-type resin, and epoxy-type resin.

The design layer 25 is not limited to the resin described above. It may consist of a metallic film such as aluminum, chrome, copper, nickel, indium, tin, and silicon oxide by vacuum vapor deposition, plating or the like. Note that the film thickness of the design layer 25 is preferably set in a range from 0.5 to 50 μm in order to obtain sufficient design property. In the case of consisting of a metallic film layer, a range from 50 Å to 1200 Å is preferable.

The adhesive layer 26 is for attaching the design layer 25 to the surface of a molded product. The materials thereof include acrylic-type resin, nitrocellulose-type resin, polyurethane-type resin, chlorinated rubber type resin, vinyl chloride-vinyl acetate copolymer type resin, polyamide-type resin, polyester-type resin, epoxy-type resin, polycarbonate-type resin, olefin-type resin, and acrylonitrile-butadien-styrene resin. The film thickness of the adhesive layer 26 is preferably in a range of 0.5 to 50 μm.

The design layer 25 can be printed on the peel-off layer 24 by well-known gravure printing.

The gravure printing is printing in which ink is held in fine recesses of a plate, and printing is performed by transferring the ink to the peel-off layer 24 with a pressure of an impression cylinder. Ink to be used is basically of solvent type, which has an advantage that the adhesive property is excellent even with respect to a plastic film with bad wettability such as the peel-off layer 24.

Further, since the surface of a plastic film does not absorb ink and is very smooth, it is possible to create a precise design by utilizing the gravure printing with ink excellent with the peel-off layer 24.

Note that a method of forming the design layer 25 on the peel-off layer 24 is not limited to the gravure printing. For example, any printing method capable of attaching the design layer 25 to the peel-off layer 24 such as offset printing, screen printing, coating or dipping is applicable.

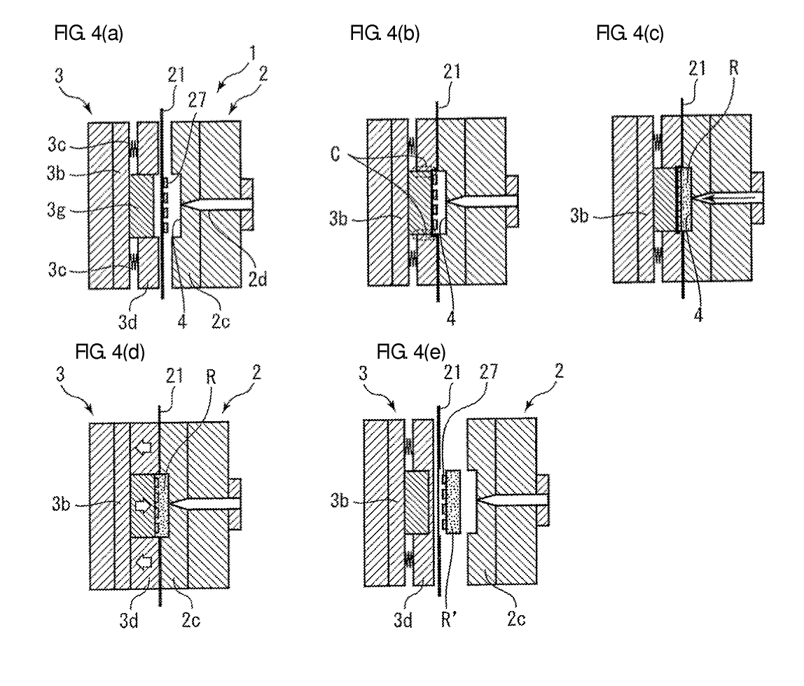

FIG. 4 shows a method of performing inmold printing by using the mold 1 shown in FIG. 2 and the transfer film 21.

In the description below, same constitutional elements as those in FIG. 2 are denoted by the same reference numerals and the explanation thereof is omitted.

In FIGS. 4a to 4e, step (a) shows a state of positioning the transfer film 21, step (b) shows a mold contacting state, step (c) shows a mold resin injecting/filling state, step (d) shows a compressing state, and step (e) shows a mold removing state, respectively.

In the inmold printing, the transfer film 21 passes between the fixed mold 2 and the movable mold 3. The transfer film 21 passing through the both molds is disposed such that the decorative layer 27 faces the fixed mold 2.

In the fixed die plate 2c, the hot runner 2d for injecting transparent resin is formed toward the transfer film 21. The hot runner 2d forming part is connected with a nozzle of an injection molding device not shown.

As shown in step (a), the transfer film 21 is fed between the fixed mold 2 and the movable mold 3 to thereby perform positioning. That is, positioning is performed such that the transparent resin formed by being injected into the cavity 4 and the design formed on the transfer film 21 are arranged in a prescribed manner.

As shown in step (b), when the positioning of the transfer film 21 is completed, the movable mold 3 is moved to the fixed mold 2 side, and the slide board 3d is contacted with the fixed die plate 2c by the spring force. The compression allowance of the springs 3c and 3c is set to 0.3 mm, for example.

As shown in step (c), the transparent resin R is injected in the cavity 4.

Then, as shown in step (d), the movable mold 3 is moved so as to set the compression allowance of the spring 3c to 0 mm such that the slide board 3d and the movable die plate 3b contact closely.

Then, after the injected transparent resin is hardened, the fixed mold 2 and the movable mold 3 are opened as shown in step (e), and the base film 22 is peeled off since the peel-off layer 24 (see FIG. 3) is provided, so the molded product R′ remains on the fixed die plate 2c side. On the molded surface of the molded product R′, the design is transferred and integrated with the molded product R′. Then, the molded product R′ is separated from the fixed die plate 2c.

In this way, by performing inmold printing with the transfer film 21 being interposed between the fixed mold 2 and the movable mold 3, it is possible to prevent a reduction in yield affected by abrasion powders generated in the core sliding part C while performing decoration by transfer simultaneously.

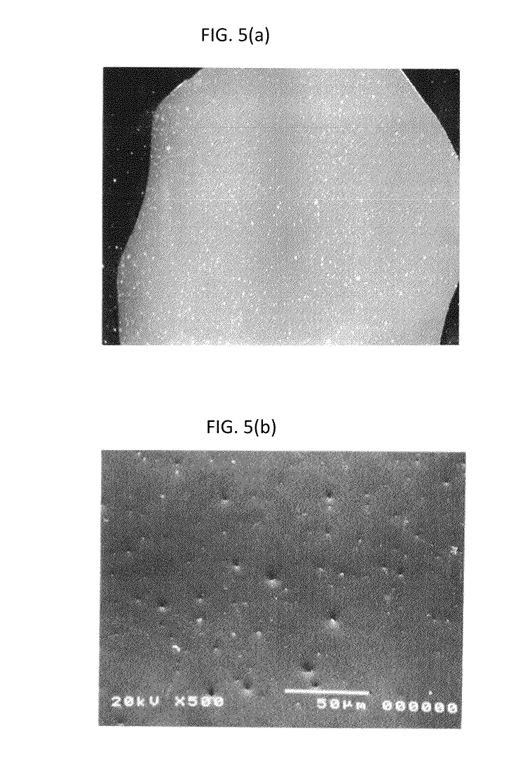

FIGS. 5a and 5b show a surface (rear face) of a molded product after conventional compression molding, captured by an optical microscope, in which FIG. 5a shows one magnified 50 times, and FIG. 5b shows one magnified 500 times.

As obvious from FIG. 5a, thousands of white tarnishes caused by spots are generated on the surface of the molded product, and as obvious from FIG. 5b, the spots generate craters.

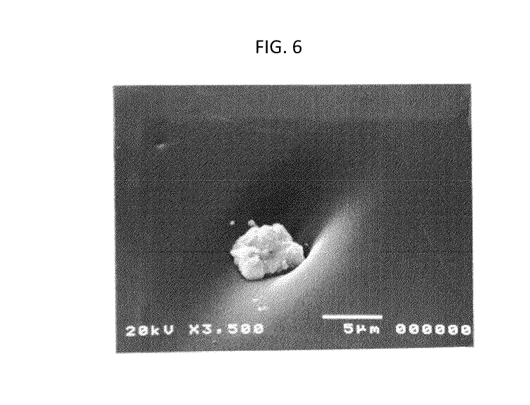

FIG. 6 shows the crater further magnified 3500 times, in which a foreign article generating the crater is clearly shown. Through analysis of the foreign particle, Fe+Cr is detected and it is confirmed as an abrasion powder.

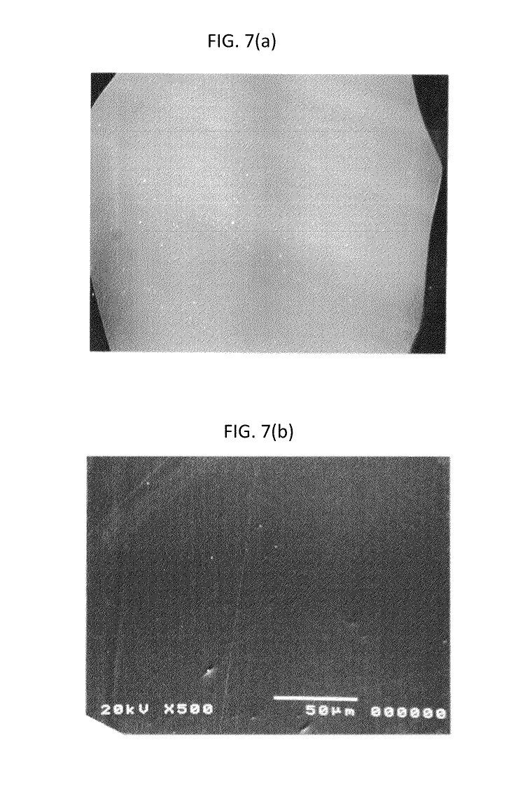

On the other hand, FIGS. 7a and 7b show a surface (rear face) of a molded product molded by the compression molding method of the present invention, captured under the same conditions.

As obvious from FIG. 7a, white tarnishes are solved completely, and as obvious from FIG. 7b, craters are seldom generated.

As described above, by performing compression molding with the film F or the transfer film 21 being interposed between the fixed mold 2 and the movable mold 3, it is confirmed that a molded product can be manufactured without being affected by abrasion powders generated in the core sliding part C.

The compression molding method of the present invention is preferable for thin-wall moldings and optical moldings using transparent resin, particularly.

Specific examples of thin-wall moldings include transparent display panels of mobile telephones and PDA (Personal Digital Assistances).

Specific examples of optical moldings include plastic lens components provided in cameras of mobile telephones, plastic lens components used in other electronic equipment, plastic lens components of optical equipment, and optical discs as recording media such as CD (Compact Disc) and DVD (Digital Versatile Disk).

### INDUSTRIAL APPLICABILITY

The present invention is preferable for forming molded products, that is, spectacle lenses and optical lenses in particular, in which molding must be carried out while preventing abrasion powders generated from the sliding face of mold components from being contaminated in the products.

1-5. (canceled)

6. A compression molding device including a fixed mold and a movable mold arranged opposite each other, in which a slide board connected with a movable die plate on a movable mold side via a spring is contacted with a parting face of the fixed mold by a spring force, and the movable mold is further advanced after resin is supplied into a cavity inside the mold, and the resin filled in the cavity is compressed and molded by a core, provided in the movable mold, penetrating through the slide board, wherein
the device is configured such that one surface of the resin in the cavity and the core is divided with a thermoplastic resin film at a time of compression molding.

7. The compression molding device according to claim 6, wherein the device includes a suction passage communicating with a gap in the core sliding part inside the movable mold, and is configured such that the suction passage is connected with a vacuum pump, and the thermoplastic resin film disposed between the fixed mold and the movable mold is attached closely to the compression face of the core.

8. The compression molding device according to claim 6, wherein the thermoplastic resin film is formed of a resin film in a band shape, and is configured so as to be unwound from a roll and to pass through the mold intermittently.
